(19) United States
(12) Patent Application Publication
(10) Pub. No.: US 2023/0005201 A1
(43) Pub. Date: Jan. 5, 2023

(54) HARMONY-AWARE HUMAN MOTION SYNTHESIS WITH MUSIC

(71) Applicant: TCL Research America Inc., San Jose, CA (US)

(72) Inventors: Xinyi WU, San Jose, CA (US); Haohong WANG, San Jose, CA (US)

(21) Appl. No.: 17/360,493

(22) Filed: Jun. 28, 2021

(51) Int. Cl. G06T 13/20; G06K 9/00; G10L 25/51; G06T 7/73; G06N 3/04; G06N 3/08

(52) U.S. Cl. CPC G06T 13/205; G06K 9/00342; G10L 25/51; G06T 7/73; G06N 3/0454; G06N 3/088; G06T 2207/10016; G06T 2207/20081; G06T 2207/20084; G06T 2207/30196

(57) ABSTRACT

A method and device for harmony-aware audio-driven motion synthesis are provided. The method includes determining a plurality of testing meter units according to an input audio, each testing meter unit corresponding to an input audio sequence of the input audio, obtaining an auditory input corresponding to each testing meter unit, obtaining an initial pose of each testing meter unit as a visual input based on a visual motion sequence synthesized for a previous testing meter unit, and automatically generating a harmony-aware motion sequence corresponding to the input audio using a generator of a generative adversarial network (GAN) model. The GAN model is trained by incorporating a hybrid loss function. The hybrid loss function includes a multi-space pose loss, a harmony loss, and a GAN loss. The harmony loss is determined according to beat consistencies of audio-visual beat pairs.

### FIELD OF THE DISCLOSURE

The present disclosure relates to the field of image processing technologies and, more particularly, relates to a method and device for harmony-aware audio-driven motion synthesis.

### BACKGROUND

Machine-based generation is widely used in the tasks of producing music videos, speech editing, and animation synthesis, where harmony represents the consistent perception of rhythms, emotions, or visual appearances in the output subjectively.

As a typical problem in audio-visual cross-domain generation, the task of audio-driven motion synthesis gains much attention in character animation, video generation and choreograph. The traditional methods tackle the audio-to-visual generation by retrieving visual clips that share the feature-level similarity with the given music. Different from regular motion synthesis, when conditioned with music, people are found to be sensitive to the inharmonious synthesized motions, which damages the qualitative evaluation heavily. Harmony is considered as one of the most important factors that highly influence the quality assessment of cross-domain results. However, the feeling of harmony relies on perceptual judgement. This may be challenging to enhance the audio-visual harmony in audio-driven motion synthesis tasks.

The disclosed method and system are directed to solve one or more problems set forth above and other problems.

### BRIEF SUMMARY OF THE DISCLOSURE

One aspect of the present disclosure provides a method for harmony-aware audio-driven motion synthesis applied to a computing device. The method includes determining a plurality of testing meter units according to an input audio, each testing meter unit corresponding to an input audio sequence of the input audio, obtaining an auditory input corresponding to each testing meter unit, obtaining an initial pose of each testing meter unit as a visual input based on a visual motion sequence synthesized for a previous testing meter unit, and automatically generating a harmony-aware motion sequence corresponding to the input audio using a generator of a generative adversarial network (GAN) model. The GAN model is trained by incorporating a hybrid loss function. The hybrid loss function includes a multi-space pose loss, a harmony loss, and a GAN loss. The harmony loss is determined according to beat consistencies of audio-visual beat pairs.

Another aspect of the present disclosure provides a device for harmony-aware audio-driven motion synthesis, including a memory and a processor coupled to the memory. The processor is configured to perform a plurality of operations including determining a plurality of testing meter units according to an input audio, each testing meter unit corresponding to an input audio sequence of the input audio, obtaining an auditory input corresponding to each testing meter unit, obtaining an initial pose of each testing meter unit as a visual input based on a visual motion sequence synthesized for a previous testing meter unit, and automatically generating a harmony-aware motion sequence corresponding to the input audio using a generator of a generative adversarial network (GAN) model. The GAN model is trained by incorporating a hybrid loss function. The hybrid loss function includes a multi-space pose loss, a harmony loss, and a GAN loss. The harmony loss is determined according to beat consistencies of audio-visual beat pairs.

### BRIEF DESCRIPTION OF THE DRAWINGS

The following drawings are merely examples for illustrative purposes according to various disclosed embodiments and are not intended to limit the scope of the present disclosure.

FIG. 1 is a block diagram of an exemplary computing system according to some embodiments of the present disclosure.

FIG. 2 illustrates an exemplary harmony-aware audio-driven motion synthesis process 200 according to some embodiments of the present disclosure.

FIG. 3 illustrate exemplary GAN model training process 300 according to some embodiments of the present disclosure

FIG. 4 illustrate an extraction of meter unions based on obtained audio beats.

FIG. 5A illustrates an exemplary framework of the training process according to some embodiments of the present disclosure.

FIG. 5B illustrates an exemplary framework of the testing phase according to some embodiments of the present disclosure.

FIG. 5C illustrates an exemplary framework of the generator according to some embodiments of the present disclosure.

FIG. 5D illustrates an exemplary framework of the cross-domain discriminator according to some embodiments of the present disclosure.

FIG. 5E illustrates an exemplary framework of the spatial-temporal discriminator according to some embodiments of the present disclosure.

FIG. 6 illustrate an example of perceptual asynchronization between beats.

FIG. 7A illustrates an example comparing the frame-based visual beat detection using optical flow in prior art (left) and the skeleton-based beat extraction using motion standard derivation in prior art (right) for visual beat detection in human videos.

FIG. 7B illustrates the video frames and corresponding extracted skeleton poses from the test case using the model in prior art.

FIG. 8A is an illustration of harmony distortion between onset-based audio beats and SD-driven visual beats, the beat extraction in the audio (left) and visual (right) signals.

FIG. 8B illustrates the asynchronization between audio-visual beats under perceptual judgements.

FIG. 9 illustrates a relationship between joint velocity sum and evolution of human movements.

FIG. 10A is an illustration of the improved beat-wise synchronization based on the visual beat extraction mechanism, the beat extraction in the audio (left) and visual (right) signals.

FIG. 10B illustrates the synchronization between audio-visual beats considering joint velocity.

FIG. 11 illustrates a percentage of how many inharmonious videos have been accurately picked up according to some embodiments of the present disclosure.

FIG. 12 illustrates sample results of average FID between the generated motion sequences by models in prior art and HarmoGAN model and the human ground truth according to some embodiments of the present disclosure.

FIG. 13 illustrates a qualitative example from the dance dataset according to some embodiments of the present disclosure.

FIG. 14A illustrates performance of audio-visual harmony tested on the self-created testing dataset with the ground truth from the real dancer and results for the evaluation mechanism from HarmoGAN model and its variant according to some embodiments of the present disclosure.

FIG. 14B illustrates performance of audio-visual harmony tested on the self-created testing dataset with the ground truth from the real dancer and results for the hit rate of audio beats in the music sequences from HarmoGAN model and its variant according to some embodiments of the present disclosure.

FIG. 15A illustrates performance of audio-visual harmony for the models of prior art and HarmoGAN model and its variant tested on the Ballroom dataset for the evaluation mechanism according to some embodiments of the present disclosure.

FIG. 15B illustrates performance of audio-visual harmony for the models of prior art and HarmoGAN model and its variant tested on the Ballroom dataset for the hit rate of audio beats in the music sequences according to some embodiments of the present disclosure.

FIG. 16 illustrates the result of the participants agrees more with the perceptual harmony based on the 30 video pairs created by putting the dance videos from three models side by side according to some embodiments of the present disclosure.

FIG. 17 illustrates an example for qualitative evaluation, where the generated motion sequences are presented with the tracked audio beats to demonstrate the audio-visual harmony based on different models according to some embodiments of the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

Harmony is an essential part of artistic creation. Movie directors tend to produce appealing scenes with songs that enhance emotional expression. When musicians arrange different voice parts in a chorus, they are supposed to consider whether the combination sounds harmonious. Artists pursue harmony in their works to create the senses of beauty and comfort. Since professional skills and techniques are required to complete such creative works, to save financial cost and labor, automatic generation is gradually applied to imitate the human creation process by exploiting computational models. Similar to human work, the machine-based generation needs to obey the rule of harmony in order to produce high-quality results that satisfy human aesthetics.

Handling harmony in those generative tasks means the models should put effort into controlling the consistency between multiple signals, which is shown as the alignment of features explicitly for observation or implicitly in the latent spaces. The synchronization for different signal pairs may differ in their relevance so that in the high-related pairs, correlated features are easier to be captured and aligned. In human perception, over 90 percent of sense derives from the stimulus of visual or auditory signals and they interrelate and interact with each other during brain processing.

The present disclosure provides a method and device for harmony-aware audio-driven motion synthesis. The disclosed method and/or device can be applied in any proper occasions where human motion synthesis with music is desired. The disclosed harmony-aware audio-driven motion synthesis process is implemented based on a beat-oriented generative adversarial network (GAN) model with harmony-aware hybrid loss function, i.e., HarmoGAN model, which utilizes audio sequences or extracted auditory features to generate the visual motion sequences. The addition of harmony evaluation mechanism in the disclosed GAN model is verified to quantify the harmony between audio and visual sequences by analyzing beat consistency.

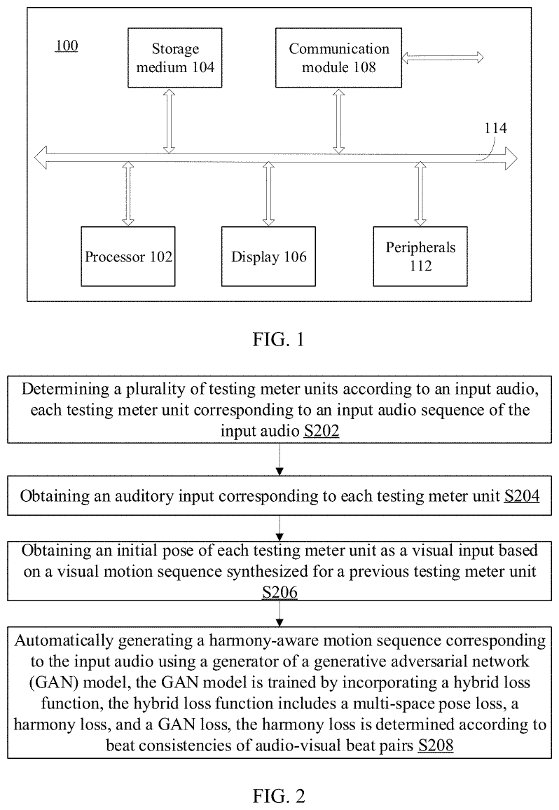

FIG. 1 is a block diagram of an exemplary computing system/device capable of implementing the disclosed harmony-aware audio-driven motion synthesis method according to some embodiments of the present disclosure. As shown in FIG. 1, computing system 100 may include a processor 102 and a storage medium 104. According to certain embodiments, the computing system 100 may further include a display 106, a communication module 108, additional peripheral devices 112, and one or more bus 114 to couple the devices together. Certain devices may be omitted and other devices may be included.

Processor 102 may include any appropriate processor(s). In certain embodiments, processor 102 may include multiple cores for multi-thread or parallel processing, and/or graphics processing unit (GPU). Processor 102 may execute sequences of computer program instructions to perform various processes, such as an audio-visual harmony evaluation and harmony-aware audio-driven motion synthesis program, a GAN model training program, etc. Storage medium 104 may be a non-transitory computer-readable storage medium, and may include memory modules, such as ROM, RAM, flash memory modules, and erasable and rewritable memory, and mass storages, such as CD-ROM, U-disk, and hard disk, etc. Storage medium 104 may store computer programs for implementing various processes, when executed by processor 102. Storage medium 104 may also include one or more databases for storing certain data such as video data, training data set, testing video data set, data of trained GAN model, and certain operations can be performed on the stored data, such as database searching and data retrieving.

The communication module 108 may include network devices for establishing connections through a network. Display 106 may include any appropriate type of computer display device or electronic device display (e.g., CRT or LCD based devices, touch screens). Peripherals 112 may include additional I/O devices, such as a keyboard, a mouse, and so on.

In operation, the processor 102 may be configured to execute instructions stored on the storage medium 104 and perform various operations related to a harmony-aware audio-driven motion synthesis method as detailed in the following descriptions.

FIG. 2 illustrates an exemplary harmony-aware audio-driven motion synthesis process 200 according to some embodiments of the present disclosure. The process 200 may be implemented by a harmony-aware audio-driven motion synthesis device which can be any suitable computing device/server having one or more processors and one or more memories, such as computing system 100 (e.g., processor 102).

As shown in FIG. 2, harmony-aware audio-driven motion synthesis method consistent with embodiments of the present disclosure includes following processes.

At S202, a plurality of testing meter units are determined according to an input audio, each testing meter unit corresponding to an input audio sequence of the input audio.

At S204, an auditory input corresponding to each testing meter unit is obtained.

At S206, an initial pose of each testing meter unit is obtained as a visual input based on a visual motion sequence synthesized for a previous testing meter unit; and

At S208, a harmony-aware motion sequence corresponding to the input audio is automatically generated using a generator of a GAN model. The GAN model is trained by incorporating a hybrid loss function. The hybrid loss function includes a multi-space pose loss, a harmony loss, and a GAN loss. The harmony loss is determined according to beat consistencies of audio-visual beat pairs.

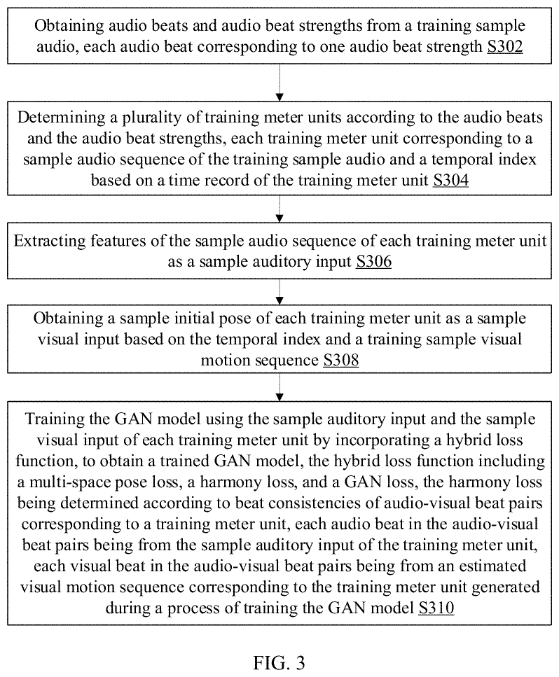

As shown in FIG. 3, training the GAN model includes following processes.

At S302, audio beats and audio beat strengths are obtained from a training sample audio. Each audio beat corresponds to one audio beat strength.

Spectrogram analysis is widely used to obtain the audio beats Bₐ(t) in audio processing. The spectrogram of given audio sequences A(t) can be obtained by the time-windowed Fast Fourier Transform (FFT). With the estimation of the amplitude of the spectrogram, the beats are extracted by looking for distinct amplitude changes in the time domain, which could be described as:

$$ℊ ( t ) = Amp ( F F T ( A ( t ) ) ) \qquad ( 1 )$$

$$\begin{matrix}{B}_{a} ( t ) = \{ \begin{matrix}1 & if ℊ ( t ) - ℊ ( {t}^{′} ) > {c}_{1} , ∀ {t}^{′} ∈ {\dot{U}}_{a} ( t , {t}_{0} ) \\ 0 & otherwise\end{matrix} & ( 2 )\end{matrix}$$

Amp denotes the function or model that estimates the amplitude of the spectrogram. The positive threshold c₁ is set to determine the existence of beats at time t which satisfies Bₐ(t)=1 compared with any other t′ in its punctured neighborhood \dot{U}ₐ determined by a pre-defined radius t₀. In the mainstream methodologies, amplitude estimation is conducted by deriving the onset strengths from the obtained spectrogram. The audio beats Bₐ (t)=1 is then determined by the occurrence of the peak in each onset envelope.

In some embodiments, to obtain the audio beats, the mainstream approach making use of the onset strength is exploited. All the audio beats can be practically processed by methods in the open-source package LibROSA, which provides the implementations of the onset-driven beat detection for audio signals. In some embodiments, the audio beat strengths are per-computed to estimate the tempo based on the auto-correlation inside onset envelope by the analysis of Mel spectrogram. Referring to Equations. (1) and (2), the audio beat Bₐ(t)=1 can be explained by the case where there is a peak in the onset envelope at consistent t with the obtained tempo. To assemble the valid beats in Bₐ(t), the position-based beats {pₐ(b)|b=1,2, . . . , N} are formed to collect all the positions in time t of occurred N beats that satisfy Bₐ(t)=1.

Simultaneously, the corresponding strengths of beats pₐ(b) are thus represented with the peak values as sₐ(b).

At S304, a plurality of training meter units are determined according to the audio beats and the audio beat strengths. Each training meter unit corresponds to a sample audio sequence of the training sample audio and a temporal index based on a time record of the training meter unit.

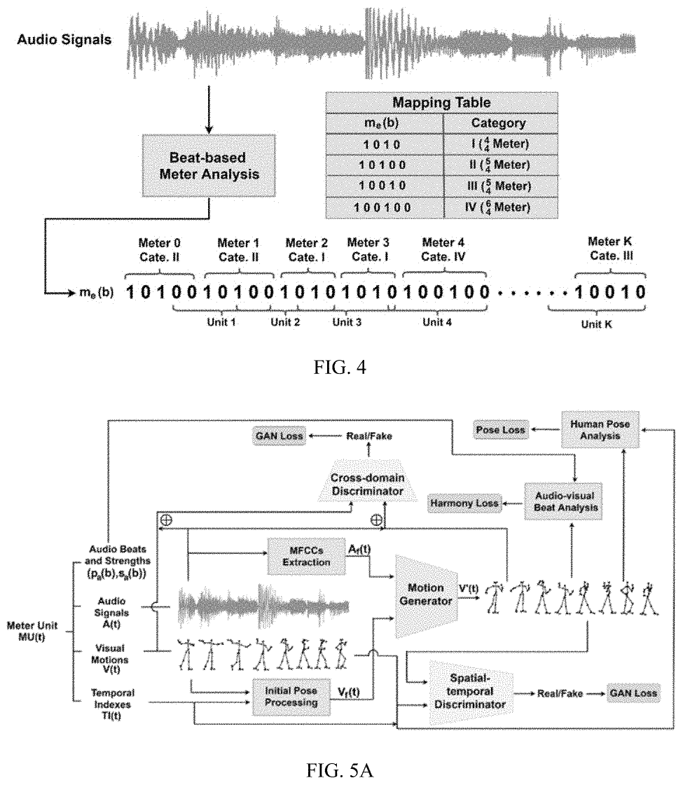

FIG. 4 illustrates the extraction of meter unions based on the obtained audio beats. As shown in FIG. 4, given the audio sequences A(t), the audio beats pₐ(b) and their strengths sₐ(b) can be obtained. Whether the beat is strong or weak mₑ(b) can be determined by comparing the strength with its previous beat as:

$${m}_{e} ( b ) = \{ \begin{matrix}1 & if {s}_{a} ( b ) > {s}_{a} ( b - 1 ) \\ 0 & otherwise ,\end{matrix} \qquad ( 3 )$$

mₑ(b)=1 means that the beat is strong and 0 is week. For example, with a quarter note, strong-weak beat combinations are mapped into 3 meter unit types, which are 4/4 , 5/4, and 6/4 in 4 categories totally. Several beats in the previous meter unit are added in a current meter unit for the transitions between meter units to form the meter units into the unified beat length to describe the flow of musical rhythms. In the example shown in FIG. 4, each meter unit includes 7 beats (unified beat length) and one of the four music meter types listed in the mapping table. If the music meter type has 4 beats, 3 previous beats are added to the current meter unit to fill up to the 7 beats, such as Unit 2 and Unit 3 in FIG. 4. Similarly, if the strong-weak beat combination has 5 beats, 2 previous beats are added to the current meter unit to fill up to the 7 beats, such as Unit 1 in FIG. 4. The first strong-weak beat combination is discarded since there is not previous beat to fill up to the unified length. The last meter unit ends with the last strong-weak beat combination. In this way, the meter units can be extracted based on recognized strong-weak beat combinations of the audio beats. In some embodiments, testing meter units may be obtained from a testing audio input (e.g., S202) in a similar manner as the training meter units being extracted from a training sample audio (e.g., S304).

Meter units are used as a basic unit of audio and visual pairs in the audio-driven video synthesis process. For each meter unit MU, the start time and end time are recorded as MU(t), t ∈ [tₛₜₐᵣₜ, t_{end}]. The disclosed process can find, for a meter unit corresponding to an audio sequence A(t), a motion sequence V(t) that matches the audio sequence with desirable harmony by using a generator of a trained GAN model, and repeat the similar process for all meter units. According to the time records, when training the GAN model, known audio-visual matched videos training samples having desirable harmony are obtained and corresponding audio and motion sequences A(t) and V(t) can be extracted as the ground-truth pairs, including the audio beats pₐ(b) and their beat strengths sₐ(b).

Meanwhile, the temporal indexes TI(t) is formed in binary to denote the separation between the current meter unit and the previous meter unit, where TI(t) is set to 1 if the time belongs to the priors from the previous meter unit. Using the example shown in FIG. 4, the first three beats of meter unit 2 are marked as belonging to the priors from the previous meter unit (TI(t)=1), and the remaining four beats of meter unit 2 are marked as belonging to the current meter unit (TI(t)=0).

In some embodiments, training the GAN model also includes segmenting audio-visual clips based on the plurality of training meter units temporally and inputting the segmented audio-visual clips for the training. The initial pose of each training meter unit is obtained from a corresponding audio-visual clip that contains the sample audio sequence. In other words, if the human motion sequences are harmonious with the given auditory rhythms, the human motion sequences can show regular recurring movement units related to the audio beats. It can be assumed that the correlation exists between such movement units and the obtained audio beats. Thus, the audio-visual clips are segmented based on the defined meter units temporally as input for training to strengthen the learning of beat-driven cross-domain unit mapping in a deep model consistent with the embodiments of the present disclosure, which can indirectly benefit the audio-visual harmony for the generation.

At S306, features of the sample audio sequence of each training meter unit are extracted as a sample auditory input.

In some embodiments, features of the input audio sequence A(t) of the current meter unit are extracted as an auditory input A_{f}(t). For example, for A(t), the features of Mel Frequency Cepstral Coefficients (MFCCs) are extracted as the auditory input A_{f}(t). In some embodiments, auditory input corresponding to a testing meter unit (e.g., S204) may be obtained in a similar manner as obtaining training sample auditory input (e.g., S306).

At S308, a sample initial pose of each training meter unit is obtained as a sample visual input based on the temporal index and a training sample visual motion sequence.

In some embodiments, for training, the initial poses V_{f}(t) can be obtained based on TI(t) and V(t) by:

$${V}_{f} ( t ) = \{ \begin{matrix}V ( t ) & if TI ( t ) = 1 \\ \frac{{\sum }_{t} V ( t ) \times TI ( t )}{{\sum }_{t} TI ( t )} & othe r w i s e ,\end{matrix} \qquad ( 4 )$$

That is, the visual features V_{f}(t) keep the movements from the previous meter unit as priors and use the mean pose for one previous meter unit as initialization for the current meter unit. Using the example shown in FIG. 4, the visual features or initial poses corresponding to the first three beats of meter unit 3 are obtained from motion sequence corresponding to the last three beats of meter unit 2, and the pose of each of the remaining four beats of meter unit 3 is a mean pose of the poses corresponding to the last three beats of meter unit 2. This allows the network to enhance the temporal consistency in the synthesis of human motion.

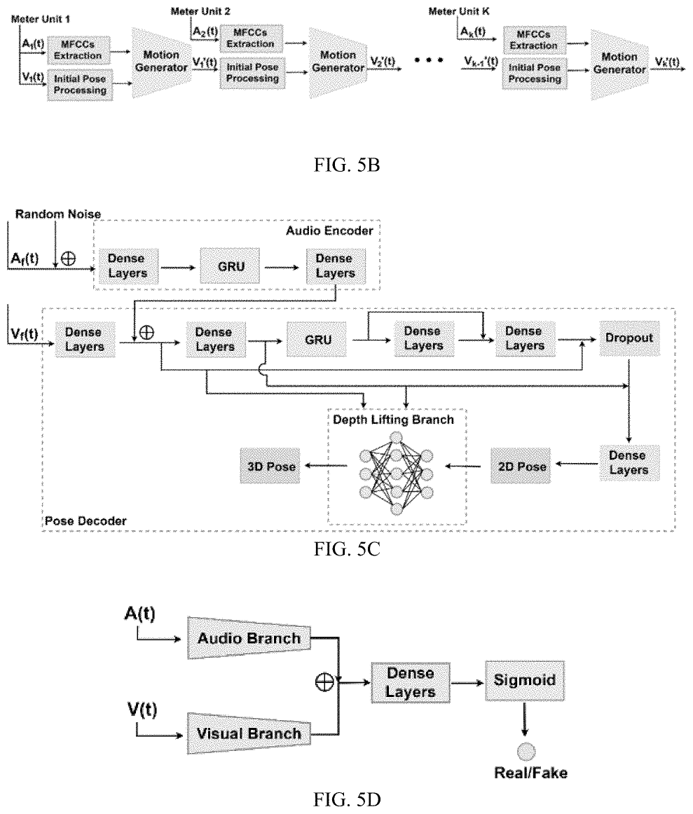

The auditory input (i.e., the audio features extracted at S304) and the visual input (i.e., the initial poses obtained at S306) can be inputted into a generator of a GAN model. The structure of the generator G can be summarized as G (A_{f}(t), V_{f}(t))=V′(t), where V′(t) denotes the generated motion sequence for a meter unit. FIG. 5B demonstrates the overview of the testing phase. Based on the generator structure, as shown in FIG. 5B, in the testing phase, V_{f}(t) are processed from the previously synthesized motions, which contributes to the generation of consistent human motions recurrently with meter units for audio clips in random duration. In some embodiments, the initial pose of the first meter unit may be pre-assigned and input into the generator.

At S310, the GAN model is trained using the sample auditory input and the sample visual input of each training meter unit by incorporating a hybrid loss function, to obtain a trained GAN model. The hybrid loss function includes a multi-space pose loss, a harmony loss, and a GAN loss. The harmony loss is determined according to beat consistencies of audio-visual beat pairs corresponding to a training meter unit. Each audio beat in the audio-visual beat pairs is from the sample auditory input of the training meter unit. Each visual beat in the audio-visual beat pairs is from an estimated visual motion sequence corresponding to the training meter unit generated during a process of training the GAN model.

Since GANs shown their outstanding power in visual generation tasks, GANs are also popular to be used in cross-domain generation. FIG. 5A demonstrates the overview of the whole training process. In some embodiments, for GAN model training, the GAN model includes a generator, and a cross-domain discriminator and a spatial-temporal discriminator for jointly supervising the generator. In some embodiments, to supervise the reality of produced human motions, apart from a cross-domain discriminator, which is widely used to control the validity of feature conversion in different domains, a spatial-temporal pose discriminator is utilized to judge realistic movements both spatially and temporally. In addition to the GAN losses provided by discriminators, the multi-space pose loss and the beat-driven harmony loss based on the attentional harmony mechanism are incorporated as the regularization for the generator. Such harmony-aware hybrid loss functions can guide the generator to output human-like motion sequences that are harmonious with the given music by constraining the consistency between the pre-computed audio beats and visual beats extracted from the generated motions.

In the tasks of audio-driven motion synthesis, the network is fed with the input of audio sequences or extracted auditory features to generate the visual motion sequences. Due to the difficulty of cross-domain synthesis, it is always a problem to encourage effective feature transformation in the architecture. To solve this problem, the encoder-decoder structure is considered to handle the translation between sequences to sequences. Taken into consideration the chronological order in the input and output sequences, recurrent structures are introduced into the architecture of encoder and decoder to obtain features considering temporal correlations. The Gated Recurrent Units (GRUs), as a typical structure of recurrent neural network (RNN), can outperform the common Long Short Term Memory (LSTM) structure in sequence learning for its fewer parameters and reduced computation. In some embodiments, as shown in FIG. 5C, the generator G includes a GRU-based audio encoder and pose decoder.

In addition, differently from analyzing only the audio features outputted from the encoder in the decoding of poses, the initial pose features are concatenated with the audio features to enhance cross-domain learning for the decoder. The skip connections are also applied to intentionally add the audio-visual features into the future layers.

Because the generator G is aimed of producing human motions in 3D poses, it is more difficult to accurately estimate the additional depth dimension compared to synthesizing 2D motions. In some embodiments, the 2D poses are estimated first, and then a depth lifting branch is constructed to produce the 3D poses based on the 2D estimation. Taking advantage of the similarity between the 2D and 3D poses, the depth can be efficiently generated.

In the music-to-motion synthesis, not only the consistency of content style between the generated human movements and target audio sequences is needed to be supervised, but also the reality of synthesized human motions. Thus, a cross-domain discriminator D_{cd} and a spatial-temporal discriminator Dₛₜ are built to guide the network to learn the global content consistency between the audio-visual pairs and the targeted pose flow in the spatial and temporal domain, respectively.

In some embodiments, as shown in FIG. 5D, in the cross-domain discriminator D_{cd}, for any audio-visual pair (A(t), V(t)), a two-branch classification network is leveraged to judge the global style consistency. After the extraction of the audio and visual features separately, the audio and visual features are concatenated together and classify the similarity based on obtained audio-visual features. The cross-domain discriminator D_{cd} can improve the reasonable cross-domain translation for the generator G.

In some embodiments, for penalizing the unrealistic produced motions, such as distorted human poses and unnatural transition between movements, the spatial-temporal discriminator Dₛₜ is constructed by applying a temporal progressing network. As shown in FIG. 5E, the input motion sequences V(t) are segmented evenly into 5 parts based on the time duration. By repeating the feature extraction and the concatenation of obtained spatial features progressively in chronological order, the spatial-temporal discriminator Dₛₜ can lead the generator G to understand the spatial-temporal relationship of human motions in the ground truth data.

Harmony plays an important role in the evaluation of generated cross-modal results. Since the sense of vision and hearing are highly related and affect each other in brain processing, harmony is especially concerned in the tasks of audio-to-visual or visual-to-audio generation. Taking the example of audio-driven human motion synthesis, in the quality assessment the audio-visual harmony is emphasized that the synthesized movements should be rhythmic and harmonious with the music. In other words, the rhythms in the audio and visual sequences are required to be consistent temporally in order to satisfy the perceptual harmony. Since the feelings of rhythm rely on subjective human perception, given the audio sequences A(t) and visual sequences V(t) as functions of time t, it is an important topic to approximate the perceptual judgement of harmony into quantitative measurements as:

h=H(A(t), V(t)) (5)

H denotes the algorithm that analyzes the harmony between the cross-domain signals and h is a scalar representing the quantified judgement of harmony.

Referring to the rules that detect audio beats, the visual beats Bᵥ(t) are similarly extracted based on the analysis of motion trend between visual sequences V(t) and V(t-t₀). When there is a drastic change in the motion trend occurs, the time t is considered as the occurrence of a beat, which could be depicted as:

$$d ( t ) = M T ( V ( t ) , V ( t - {t}_{1} ) ) \qquad ( 6 )$$

$${B}_{v} ( t ) = \{ \begin{matrix}1 & if d ( t ) - d ( t ' ) > {c}_{2} , ∀ {t}^{′} ∈ {\dot{U}}_{v} ( t , {t}_{2} ) \\ 0 & othe r w i s e\end{matrix} \qquad ( 7 )$$

MT denotes the function or model that estimates the motion trend during t₁ (a pre-defined constant value) and c₂ is a positive value that controls the threshold to obtain the beat at time t where Bᵥ(t)=1 stands in comparison with any other t′ in its punctured neighborhood \dot{U}ᵥ radiused by pre-defined constant t₂. To process the general pixel-based visual signals, the use of optical flow can capture the motion trend in the moving events. With the quantification of optical flow, the visual beats can be obtained by deriving the local maximums that denote the obvious changes in movements. When focusing on only the human motion in such pixel-based signals, the skeleton-driven method can be used to specify the motion trend for the pure skeleton-based motions extracted from visual signals. Thus, the estimation of motion trend can be converted to analyzing the directions of body movements by joint-based standard derivation. The visual beats Bᵥ=1 thus are defined as the distinct directional changes in the motion sequences.

Based on the observed audio and visual beats, a common assumption is derived to tackle rhythmic consistency that the appearance of every audio beat is supposed to synchronize with that of the visual beat and vice versa. Following such assumption, the existing strategies evaluate the quantified audio-visual harmony h by performing the alignment based on the extracted beats, which extend the Eq. (5) as:

h=L(fₐ(A(t)), fᵥ(V(t)))=L(Bₐ(t), Bᵥ)) (8)

fₐ and fᵥ denote functions for beat detection in the audio and visual signals, respectively. L represents the alignment algorithm. In some embodiments, the algorithm L can formulate the alignment problem as analyzing the distances between the synchronized beat pairs by warping, cross-entropy, or F-score, which are effective to align the cross-domain objects.

In some embodiments, taking human video as an example, given human and their movements as the attention points, the harmony are mainly considered as the alignment between foreground human motion in the visual frames and the associated background music. To better analyze the foreground human motions, the skeletons of human are extracted to represent the human motions in videos. Hence, harmony is evaluated between the audio signals and skeleton-based human motions.

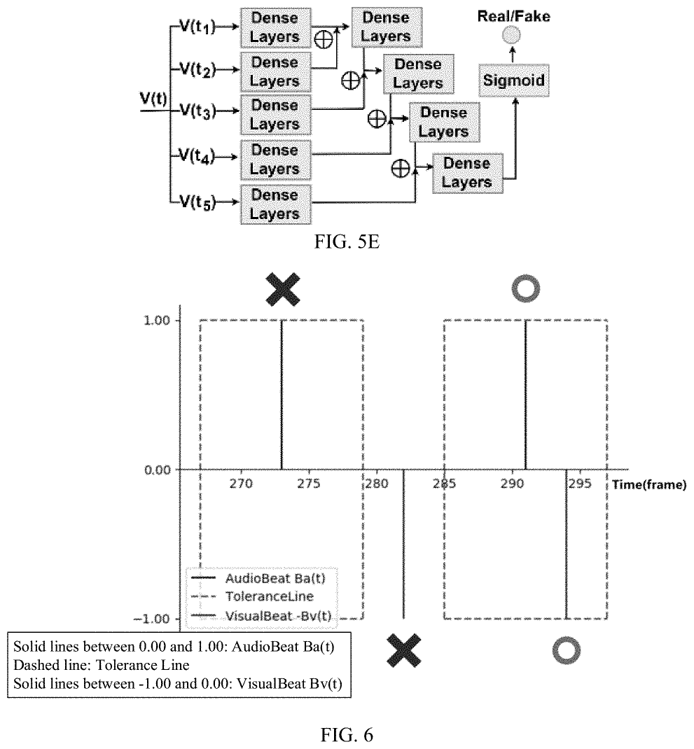

To visualize the subjective evaluation of harmony by objective expressions, based on human reaction time, the tolerance fields neighbored with audio beats are set to represent the perceptual judgement of audio-visual harmony in terms of the synchronization between beats. FIG. 6 illustrates an example of unsynchronized audio-visual beats, where the processing of beats for audio and visual signals separately does not reach a satisfactory alignment.

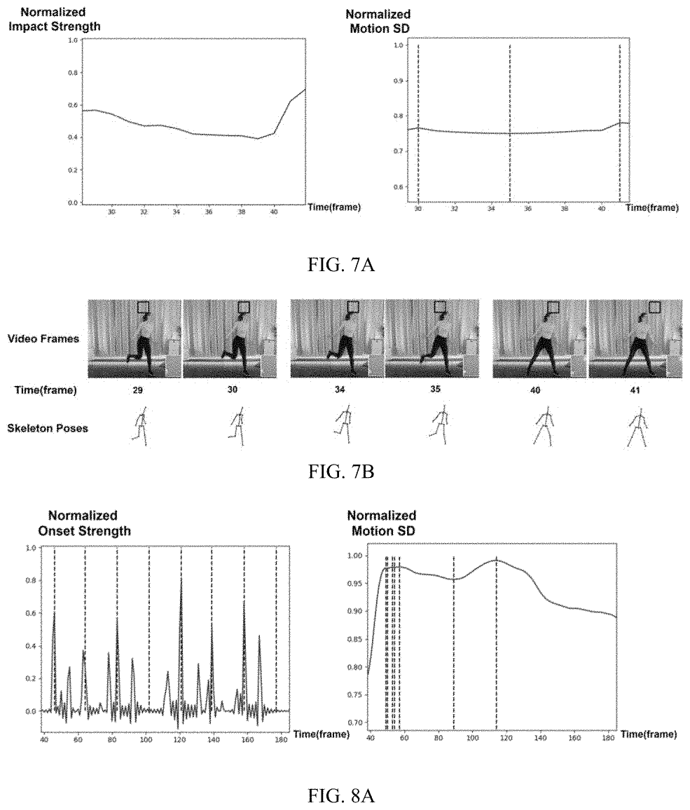

In the visual case, optical flow is often used to extract beats for general frame-based visual signals. However, when fed with human video, this approach does not function effectively compared to the skeleton-based approach. One reason is that optical flow treats the motion of each pixel almost equally where much higher weights is put on the foreground human. As shown in FIGS. 7A and 7B, with the distinct occurrences of human movement changes in the video frames perceptually, accordingly the visual beats should be obtained by the beat extraction methods. However, disturbed by possible moving events in the background, the optical flow method has difficulty in detecting beats for foreground human motions while the skeleton-based approach outperforms it significantly in obtaining visual beats that are more consistent with human perception. The joint-wise standard deviation (SD) based visual beat detection is used to represent the skeleton-based approach, where the visual beats are detected by estimating the directional changes in the body movements.

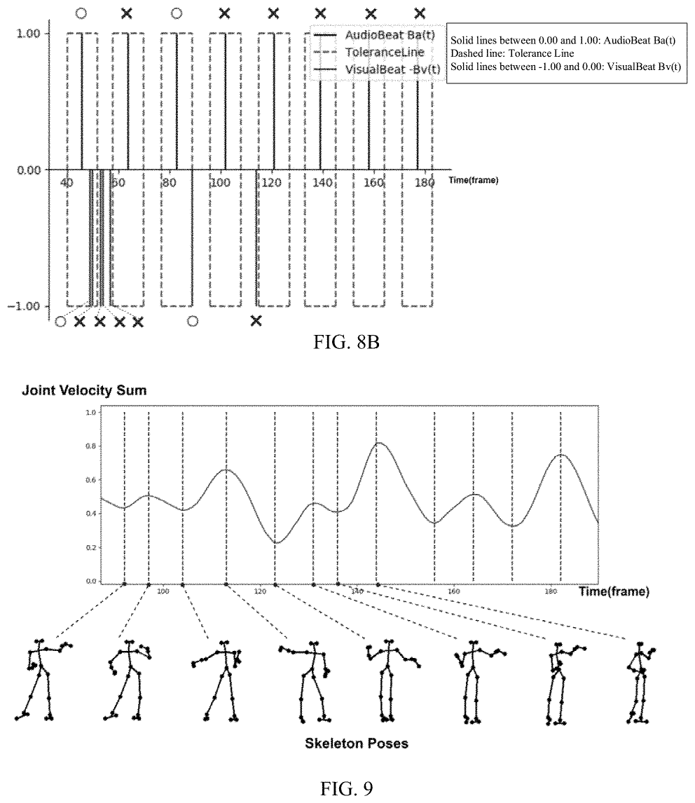

In some embodiments, the mainstream onset-based audio beat detection is combined with the SD-driven visual beat detection in the beat alignment experiment conducted on the dance dataset. Since the human reaction time is around 0.25 seconds, the radius of tolerance field for each audio beat is set to 6 frames, with the total duration of 0.24 seconds under 25 fps, to evaluate the audio-visual alignment results. However, the outcome is not very satisfactory. As shown in FIGS. 8A and 8B, the harmony distortion is quite high due to omission and redundancy between beat pairs. It reveals that, though the SD-driven visual beat detection can basically harmonize with the subjective perception, when referred with onset-based audio beats, such cross-domain audio-visual beat pairs are not consistent with each other. To cooperate with onset-based audio beats, a novel beat extraction mechanism consistent with the embodiments of the present disclosure considering velocity of joints in neighboring frames is provided to determine weights to detect visual beats that can satisfy better beat consistency in the audio-visual alignment.

In some embodiments, training the GAN model further includes detecting visual beats of the estimated visual motion sequence by considering a difference between joint velocity sums in neighboring frames of the estimated visual motion sequence.

Given the skeleton-oriented human motion sequences vₛ(t, j) with j joints at frame t obtained from V(t), the joint velocity sum Jᵥ(t) is derived by calculating the frame difference as:

$${J}_{v} ( t ) = {\sum }_{i = 1}^{j} {v}_{s} ( t , i ) - {v}_{s} ( t - 1 , i ) \qquad ( 9 )$$

i denotes the i^{th} joint. In some embodiments, the diversity and frequency can be regularized based on analyzing the joint sum.

To define the motion beats that are well-aligned with audio beats, the evolution of indivisible movement units (e.g., hand lift) is mainly focused on for the analysis of visual beats in the whole motion sequences.

FIG. 9 demonstrates the correlation between the velocity graph and the real human movements. When the change of joint velocity sum is approaching zero, it is usually related to the complement of a single movement unit. Thus, the motion beats can be defined as the peaks or valleys in the velocity graph, where the acceleration equals zero. Eqs. (6) and (7) are then reformed as:

$$\tilde{d} ( t ) = sign ( {J}_{v} ( t ) - {J}_{v} ( t - 1 ) ) \qquad ( 10 )$$

$$\tilde{{B}_{v}} ( t ) = \{ \begin{matrix}1 & if \tilde{d} ( t ) \times \tilde{d} ( t + 1 ) < 0 \\ 0 & otherwise\end{matrix} \qquad ( 11 )$$

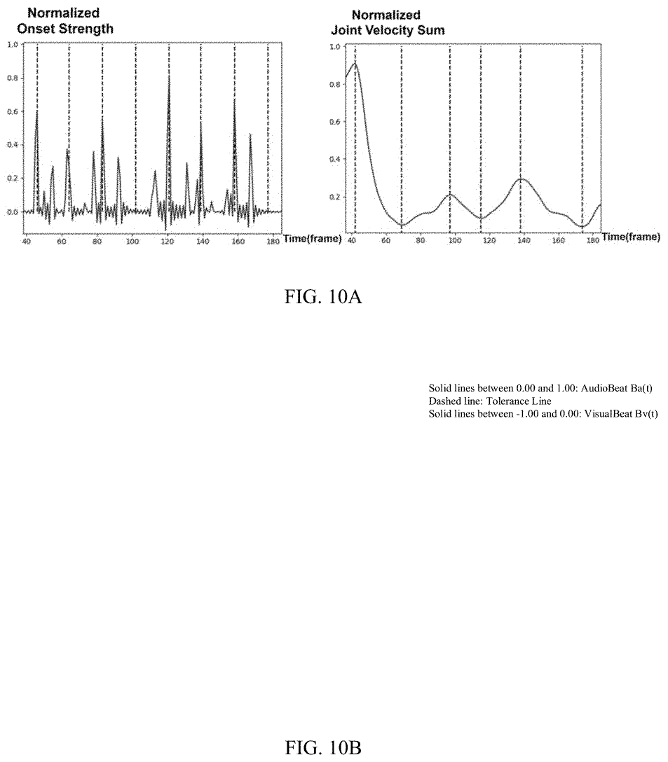

Similar with the audio case, the position-based visual beats are then formulated as {pᵥ(b)|b=1,2, . . . , M} for M valid beats satisfying \tilde{B}ᵥ(t)=1 and their strengths are assigned due to the corresponding Jᵥ(t) as sᵥ(b). FIGS. 10A and 10B demonstrate that when tested with the same conditions shown in FIGS. 8A and 8B, such obtained visual beats are basically synchronized with the occurrence of onset-based audio beats. By comparing FIG. 8B and FIG. 10B, it can be observed that the novel beat extraction mechanism consistent with the embodiments of the present disclosure outperforms the existing skeleton-based approach using motion SD by reducing the omission and redundancy for the beat-wise synchronization.

In addition to the synchronization between beats, another factor that highly influences the perception of audio-visual harmony is an attention mechanism consistent with the embodiments of the present disclosure. Since human attention is drawn for things that are more “attractive”, on the contrary, some other things may be overlooked unconsciously in the perception. Thus, to assess the audio-visual harmony close to the real human perception, the attention mechanism is needed to be introduced in the evaluation framework.

The attention mechanism reveals that unsalient objects are neglected in human perception without any awareness, which influence both vision and hearing systems. When it comes to the subjective perception of rhythmic harmony, the phenomenon of inattentional blindness and deafness may also affect the judgement based on the saliency distribution in the audio and visual rhythms. In order to approximate the perceptual measurement of harmony, an attention-based evaluation framework consistent with embodiments of the present disclosure is provided to highlight the importance of salient beats, which extends Eq. (8) as:

h=L(Wₐ(pₐ(b)), Wᵥ(pᵥ(b))) (12)

Wₐ and Wᵥ denote the attentional weighting masks derived from the audio and visual beat saliency, respectively.

In some embodiments, the beat consistencies of the audio-visual beat pairs corresponding to a training meter unit is determined by assigning a weight to each audio beat and a weight to each visual beat based on beat saliency. Because salient beats favor the perception of harmony, a weight is assigned to each beat based on its beat saliency to enhance the corresponding attentional impact in the evaluation. The beat saliency is represented by the beat strengths sₐ(b) and sᵥ(b) and adaptive weighting masks that are constructed by considering the global SD for the strengths.

In the analysis of auditory saliency, the attentional mask is built as:

Wₐ=sign(sₐ(b)−SD(sₐ(b))×λ₁) (13)

λ₁ denotes a constant scale factor to adjust the audio saliency threshold.

Differently from processing the mask for audio beats, in the visual case, the motion beats are extracted from not only the peaks but also the valleys of the joint velocity sum, which means that the direct comparison with SD is not applicable for analyzing the visual saliency. Therefore, the peak-to-valley difference is utilized to define the visual saliency strength for detecting the appearances of high-impact visual beats, which is shown as:

R(b)=|sᵥ(b)−sᵥ(b−1)|b=2, . . . , M (14)

R(b) denotes the peak-to-valley difference for each beat.

The visual saliency mask Wᵥ is then defined by utilizing the global SD as:

Wᵥ=sign(sᵥ(b)−SD(R(b))×λ₂) (15)

μ₂ denotes a constant scale factor to adjust the visual saliency threshold.

In some embodiments, the beat consistencies of the audio-visual beat pairs corresponding to a training meter unit is determined further by obtaining, among the audio-visual beat pairs of the training meter unit, attentional beats according to the weights of the audio beats and the weights of the visual beats, the attentional beats including one or more attentional audio beats and one or more attentional visual beats, and obtaining the beat strength for each of the attentional beats. By applying the weighting masks Wₐ and Wᵥ on the beats pₐ(b) and pᵥ(b), respectively, the attentional beats p′ₐ(b) and p′ᵥ(b) are obtained by extracting the positive results from Wₐ(pₐ(b)) and Wᵥ(pᵥ(b)). The corresponding beat strengths for the attentional beats are similarly defined as s′ₐ(b) and s′ᵥ(b).

The harmonious feeling in audio-visual human perception can be described as fuzzy measurement, which derives from the way that the brain of human being recognizes sensory signals. In some embodiments, the existing warping method is used to handle the beat alignment, which directly adjust the strength curve for visual beats to fit that of audio beats by applying compensations. In some embodiments, the contrastive difference is constructed by calculating cross-entropy distance between the auditory amplitude and motion labels. Because the brain of human being has limitations for recognizing the signals in precise amplitude, such strength-based fine mappings between audio-visual beats are not consistent with the real perception.

In some embodiments, the beat consistencies of the audio-visual beat pairs corresponding to a training meter unit is determined further by constructing hitting scores by counting labels in an audio and visual domain to represent aligned attentional beats in the sample auditory input and the estimated visual motion sequence, one label representing that one attentional audio beat is aligned with a corresponding attentional visual beat according to a human reaction time delay. That is, inspired by the binary labels given to present whether the audio beats and the visual beats are synchronized in the time domain (e.g., FIG. 6), a hitting score is constructed by counting the “good” labels in the audio and visual domain to represent whether the beats are aligned in the whole sequences fuzzily. To balance the audio-visual perception, the F-score method is performed to fuse the cross-domain scores for the final judgement.

Beginning with the selected high-saliency N audio beats p′ₐ(b) and M visual beats p′ᵥ(b), the Eq. (12) is reformed by using the F-score measurement as:

h=L(p′ₐ(b), p′ᵥ(b))=Fₛ(E(p′ₐ(b)), E(p′ᵥ(b))) (16)

E denotes the algorithm obtaining the hitting score in both audio and visual domain. Fₛ represents the F-score measurement.

With the observation that there is a delay between visual perception and brain-processed recognition, the assumption can be made that the beat can be considered to be hit as long as the time interval between the beat and the nearest cross-domain beat is less than the human-reaction delay. In this way, a fuzzy interval-based judgement can be made for measuring the alignment, instead of depending on precise strength-based mappings. As the synchronized beats appear in audio-visual pairs, the audio beats can be seen as anchors in the analysis of hitting. To obtain the interval, the position matrix Z(bₐ, bᵥ) is built by repeating the M visual beats p′ᵥ(bᵥ) for N times as:

∀bₐ, Z(bₐ, bᵥ)=Z(bᵥ)=p′ᵥ(bᵥ) (17)

bₐ=1,2, . . . , N and bᵥ=1,2, . . . , M.

The column-wise audio-visual interval D (bₐ, bᵥ) based on Z(bₐ, bᵥ) is computed by subtracting p′ₐ(bₐ) absolutely:

D(bₐ, bᵥ)=|Z(bₐ, bᵥ)−p′ₐ(bₐ)| (18)

Then the judgement of whether the audio beat Hp(bₐ) is hit can be obtained by comparing its minimum audio-visual interval T(bₐ) row-wisely with the pre-defined reacting delay as:

$$T ( {b}_{a} ) = min ( D ( {b}_{a} , {b}_{v} ) ) \qquad ( 19 )$$

$$Hp ( {b}_{a} ) = \{ \begin{matrix}1 & if T ( {b}_{a} ) \leq {T}_{delay} \\ 0 & otherwise ,\end{matrix} \qquad ( 20 )$$

T_{delay} is a constant frame time and Hp(bₐ)=1 denotes that there exist a synchronized audio-visual beat pair.

Finally, the hitting score hₛ can be derived by performing the weighted sum of all the hitting points as:

$${h}_{s} = {\sum }_{{b}_{a} = 1}^{N} H p ( {b}_{a} ) \times {s}_{a}^{′} ( {b}_{a} ) \qquad ( 21 )$$

Considering the normalization for the total numbers of audio beats and motion beats, the hitting score for audio harmony can be formed as

$${h}_{a} = \frac{{h}_{s}}{N} ,$$

and the hitting score for visual harmony can be formed as.

$${h}_{v} = \frac{{h}_{s}}{M} .$$

However, the correlation between hₐ and hᵥ differs from source to source. For instance, given a specific input audio-visual sequences, the obtained hₐ may be higher than hᵥ but the contrary observation can be obtained for another input sequences.

In some embodiments, the beat consistencies of the audio-visual beat pairs corresponding to a training meter unit is determined further by determining the beat consistencies using the hitting scores. That is, to balance between the audio-visual scores, in some embodiments, the final audio-visual harmony h is obtained by performing the harmonic mean, which reforms the Eq. (16) as:

$$h = {F}_{S} ( {h}_{a} , {h}_{v} ) = \frac{( 1 + {β}^{2} ) {h}_{v} {h}_{a}}{{β}^{2} {h}_{v} + {h}_{a}} \qquad ( 22 )$$

β is a pre-defined constant. Therefore, Eq. (22) can be transformed into the function of hₛ as:

$$h = \frac{( 1 + {β}^{2} ) {h}_{s}}{N {β}^{2} + M} \qquad ( 23 )$$

Implied by Equations. (22) and (23), the quantification of audio-visual harmony in the evaluation can be suggested as:

The harmony evaluation in the present disclosure is applied according to the following Lemma (1): Given an audio clip with N obtained attentional audio beats and a visual clip with M visual beats, the quantified audio-visual harmony can be uniquely determined by hₛ.

The hybrid loss function includes a multi-space pose loss, a harmony loss, and a GAN loss. The multi-space pose loss is employed to regularize the realism of the estimated human movements. In some embodiments, the multi-space pose loss includes one or more of Kullback-Leibler (KL) loss, Charbonnier-based mean squared error (MSE) loss, and Charbonnier-based VGG loss.

For distribution space, the Kullback-Leibler (KL) loss [symbol] ₖₗ function is applied based on the intermediate results of 2D poses in the generation process, shown as:

[symbol]

ₖₗ=KL( [symbol] (V_{2d}(t))∥ [symbol] (V_{2d}′(t)) (24)

[symbol] ₖₗ denotes the Kullback-Leibler (KL) loss. [symbol] denotes the operation that transforms the ground-truth 2D motion sequences V_{2d}(t) and the intermediate output V_{2d}′(t) to the probability distribution.

In the pixel space, a Charbonnier-based MSE loss [symbol] ₘₛₑ is established to constrain the generation of the 3D poses as:

$${ℒ}_{m s e} = {\sum }_{t} \sqrt{{W}_{tp} ( t ) {( V ( t ) - G ( {A}_{f} ( t ) , {V}_{f} ( t ) ) )}^{2} + {ϵ}^{2}} \qquad ( 25 )$$

ϵ is a positive constant close to zero to soothe the gradient vanishing in training. A weight mask

$${W}_{tp} ( t ) = \frac{( 2 - TI ( t ) )}{2}$$

is applied based on the temporal index TI(t) to guide the network focus more on the generation of motions for the current meter.

VGG networks are widely used to generate visual features consistent with human perception, the Charbonnier-based VGG loss [symbol] _{feat} is also performed to regularize the produced human motion in the deep feature space by:

$${ℒ}_{feat} = {\sum }_{t} \sqrt{{( V G G ( V ( t ) ) - V G G ( G ( {A}_{f} ( t ) , {V}_{f} ( t ) ) ) )}^{2} + {ϵ}^{2}} \qquad ( 26 )$$

In some embodiments, the feature-space pose loss, such as the Kullback-Leibler (KL) loss, the Charbonnier-based MSE loss, or the Charbonnier-based VGG loss, is assumed to be capable to capture the deep features for the motion flow and regularize the flow in the synthesized motions to be consistent with the ground truth.

According to the Lemma (1), the harmony between the audio and human motion sequences can be determined by evaluating the audio-visual beat consistency, which is uniquely dependent on the hitting score hₛ. Thus, the harmony loss is created by formulating the function:

[symbol]

ₕₐᵣₘₒ=E(p′ₐ(b), s′ₐ(b), VB(G(A_{f}(t), V_{f}(t))))+\sqrt{|M−N|} (27)

VB denotes the extraction of attentional visual beats with the corresponding beat strengths based on the estimated human motion sequences from the generator. Such results are then sent to the algorithm E to calculate the hitting score with the pre-computed p′ₐ(b) and s′ₐ(b). Apart from minimizing the negative hitting score, the over-frequent visual beats are penalized by adding a L1 distance comparing the number of visual beats M with N audio beats.

GANs can learn to generate outputs based on the distribution of the given data during the adversarial training by solving the min-max problem:

$${min}_{θ} {max}_{ϕ} {ℒ}_{adv} ( ϕ , θ ) = {𝔼}_{x} [ log {D}_{ϕ} ( x ) ] + {𝔼}_{Y} [ log ( 1 - {D}_{ϕ} ( {G}_{θ} ( Y ) ) ) ] \qquad ( 28 )$$

ϕ and θ denote the parameters for the discriminator and generator, respectively. x represents the ground truth data while Y is the input to the generator.

In some embodiments, training the GAN model further includes minimizing the harmony loss, the multi-space pose loss, and the GAN loss from the generator, and maximizing values of loss functions of the cross-domain discriminator and the spatial temporal discriminator to distinguish between a real training sample and a fake training sample. Thus, the cross-domain discriminator and the spatial-temporal pose discriminator try to distinguish between real and fake through maximizing the loss:

[symbol]

_{dcd} = [symbol] [log(1−D_{cd}(A(t), G(A_{f}(t), V_{f}(t))))]+ [symbol] [log D_{cd}(A(t), V(t))] (29)

[symbol]

_{dst} = [symbol] [log Dₛₜ(V(t))]+ [symbol] [log(1−Dₛₜ(G(A_{f}(t), V_{f}(t))))] (30)

On the contrary, the generator attempts to fool the discriminators by minimizing the function:

[symbol]

_{gan}= [symbol] [−log D_{cd}(A(t), G(A_{f}(t), V_{f}(t)))]+ [symbol] [−log Dₛₜ(G(A_{f}(t), V_{f}(t)))) ] (31)

In summary, combining all the loss functions above, the final loss function for the generator can be formulated as:

[symbol]

ₜₒₜₐₗ=λₖₗ [symbol] ₖₗ+λₘₛₑ [symbol] ₘₛₑ+λ_{feat} [symbol] _{feat}+λₕₐᵣₘₒ [symbol] ₕₐᵣₘₒ+λ_{gan} [symbol] _{gan} (32)

The λs denote the corresponding weight for each loss component.

In some embodiments, referring back to FIG. 2, S202 may include determining a plurality of testing meter units according to the audio beats and the audio beat strengths, each testing meter unit corresponding to an audio sequence of the input audio and a temporal index based on a time record of the testing meter unit. S204 may include: extracting features of the audio sequence of each testing meter unit as an auditory input. S206 may include: obtaining an initial pose of each testing meter unit as a visual input based on the temporal index and a visual motion sequence synthesized for a previous testing meter unit.

In some embodiments, obtaining the initial pose of each testing meter unit includes keeping the generated motion sequence from a previous testing meter unit right before a current testing meter unit in the initial pose of a current meter unit, and using a mean pose of the generated harmony-aware motion sequence from the previous testing meter unit as initialization for the current testing meter unit.

In some embodiments, in an implementation example, the dance dataset released by Tang et al. in “Dance with melody: An LSTM-autoencoder approach to music-oriented dance synthesis,” proceedings of the 26^{th} ACM international conference on Multimedia, 2018 (hereinafter, [Tang et al., 2018]), is utilized to train the HarmoGAN model, which includes 61 sequences of dancing videos performed by the professional dancer totaling 94 minutes and 907,200 frames in 25 fps. It provides the 3D human body keypoints with 21 joints collected from wearable devices and the corresponding audio tracks. The dance dataset contains four typical types of dance: cha-cha, rumba, tango, and waltz. To save the memory cost, all videos are resampled at 15 fps to create a sample dataset. 2014 clips of concatenated audio-visual input features are obtained with the corresponding target poses from the whole dance dataset, where 214 of them are selected randomly as the self-created testing data and the rest are used for model training. All the functions that handle the extraction of musical features can be found in the Librosa package of McFee et al. in “Librosa: Audio and music signal analysis in python,” proceedings of the 14^{th} python in science conference, 2015 (hereinafter, [McFee et al., 2015]).

To evaluate the harmony between the audio and synthesized audio-driven motion sequences, the HarmoGAN model is tested based on the ballroom music dataset by Gouyon et al. in “An experimental comparison of audio tempo induction algorithms,” IEEE Transactions on Audio, Speech, and Language Processing, 2006 (hereinafter, [Gouyon et al., 2006]). It extracts 698 background music clips each of 30 seconds from the online dance videos. It contains music for 7 types of dance: cha-cha, jive, quickstep, rumba, samba, tango, and waltz. In each dance category, 6 audio sequences are randomly picked to form the testing dataset. The beat-based harmony mechanism is employed to quantify the audio-visual harmony with the use of the Librosa package of [McFee et al., 2015] to obtain information of auditory beats.

HarmoGAN is implemented in PyTorch. The generator is first pretrained to prepare a reasonable initialization for the following GAN training. The pretraining ends at 225 epochs with the use of [symbol] ₚᵣₑₜᵣₐᵢₙ=0.14 [symbol] + [symbol] ₘₛₑ. The Adam optimizer proposed by Kingma and Ba in “Adam: A method for stochastic optimization,” arXir preprint arXir: 1412.6980 (2014) (hereinafter, [Kingma and Ba, 2014]), is utilized with batch size of 10. The initial learning rate is set to 0.001 and gets decreased every 50 epochs by multiplying with the factors in the order of [0.5,0.2,0.2,0.5]. Initialized with the pretrained model, GAN training is started with both the generator and discriminator networks. The weights of loss components in the hybrid loss function for our generator are set as follows: λₖₗ=0.0001, λₘₛₑ=λ_{feat}=λ_{gan}=0.001, λₕₐᵣₘₒ=1. The weight decay is set to 0.001 for the discriminators and 0.0001 for the generator. The learning rates for all the networks are initialized at 0.0001 and divided by 2 and 5 alternatively every 5 epochs. The optimizer and batch size are kept the same as in pretraining. After 45 epochs of adversarial training, the convergence is achieved to obtain the final HarmoGAN. It only takes 53 minutes to finish the whole training process based on the NVIDIA TITAN V GPU, which is fairly efficient.

For the harmony evaluation mechanism, the constant factors λ₁ and λ₂ in Eqs. (13) and (15) are set to 0.1 and 1, respectively, to obtain the attentional saliency. Meanwhile, the reaction delay is defined as 0.25 seconds, shown as T_{delay}=3.75 frames in Eq. (20) under 15 fps. When evaluating the quantified audio-visual harmony, the β of F-score in Eq. (22) is set as 2 to focus more on the hit rate of audio beats.

To confirm the assumption that the occurrence of inharmony in the audio-visual objects can be observed by human perception, a user study is conducted to test whether the participants are sensitive to the inharmonious audio-visual clips. 20 dance videos are collected, which consist of 10 harmonious contents from the ground truth in the dance dataset released by [Tang et al., 2018], and 10 inharmonious clips created by permuting the audio or visual sequences. The invited 10 participants are required to watch the whole 20 videos and provide the perceptual harmony evaluation by picking up all the sequences that are considered as inharmony.

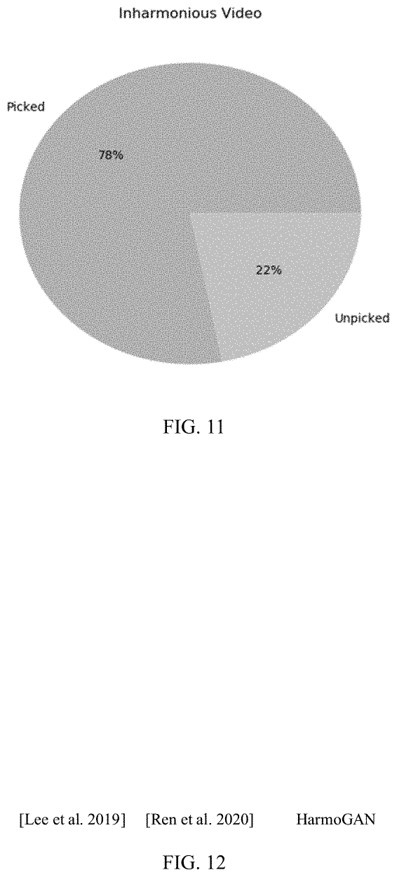

FIG. 11 illustrates the results of the user study, where 78% of the inharmonious videos have been accurately selected by the participants. Due to lack of background knowledge for professional dancing, participants have difficulty in distinguishing all the inharmonious clips from the harmonious ones. Overall, it can conclude that the audio-visual harmony affects human perception and in most cases the occurrence of inharmony can be correctly observed and judged by perception.

Before analyzing the performance of harmonization for the model, at first the HarmoGAN model is supposed to show reasonable ability to synthesize natural motion flows based on human skeletons. To evaluate the motion generation, the HarmoGAN model is tested on the self-created testing dataset obtained from the dance dataset released by [Tang et al., 2018], which can provide ground-truth dance movements performed by a real human dancer. The Fréchet Inception Distance (FID) metric proposed by Heusel et al. in “Gans trained by a two time-scale update rule converge to a local nash equilibrium,” arXir preprint arXir: 1706.08500 (2017) (hereinafter, [Heusel et al., 2015]), is utilized to measure the perceptual distance between the estimated motion sequences and the human ground truth. As there exists no standard for extracting features in pose sequences, the VGG network proposed by Simonyan and Zisserman in “Very deep convolutional networks for large-scale image recognition,” arXir preprint arXir: 1409.1556 (2014) (hereinafter, [Simonyan and Zisserman, 2014]), is employed to obtain pose features for measuring FID. The average results are shown in FIG. 12. Compared with the references from the dance generation models proposed by Lee et al. in “Dancing to music,” Advances in Neural Information Processing Systems, 2019 (hereinafter, [Lee et al., 2019]), and Ren et al. in “Self-supervised Dance Video Synthesis Conditioned on Music,” proceedings of the 28^{th} ACM International Conference on Multimedia, 2020 (hereinafter, [Ren et al., 2020]), shown in FIG. 12, it can be implied that the HarmoGAN model is competitive with those state-of-the-art models that can learn to synthesize human motions sharing high feature-space similarity with the real human movements in the training dataset.

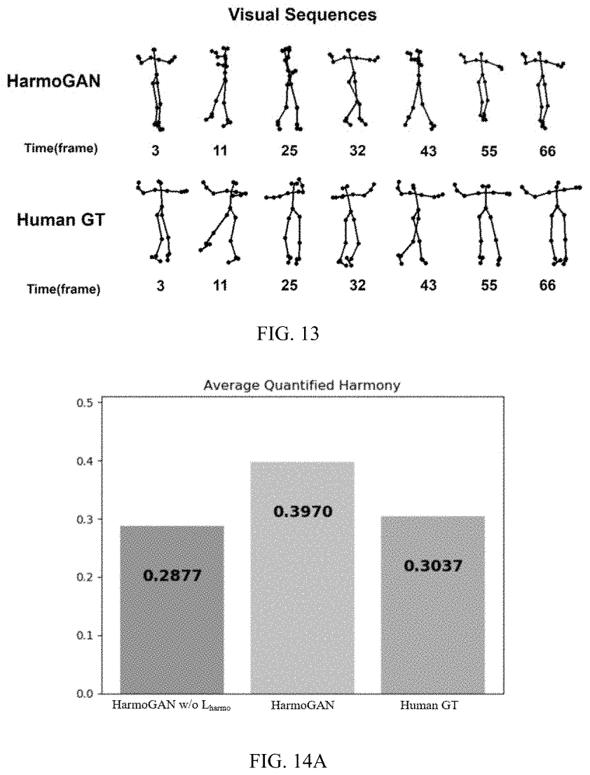

Meanwhile, in FIG. 13, an example of motion sequence pairs is presented for qualitative evaluation. The sequences of human movements synthesized by the HarmoGAN model show similar motion flows compared with the human ground truth.

To analyze the enhancement of audio-visual harmony after introducing the harmony loss into the network training, an ablation study is conducted to evaluate the performance of the HarmoGAN model with its variant without the use of [symbol] ₕₐᵣₘₒ on the self-created testing dataset, which contains relevant initial poses for the generation of motion sequences. Given the pre-computed audio beats from the music sequences, the harmony can be assessed by analyzing the audio-visual beat consistency based on the estimated human movements.

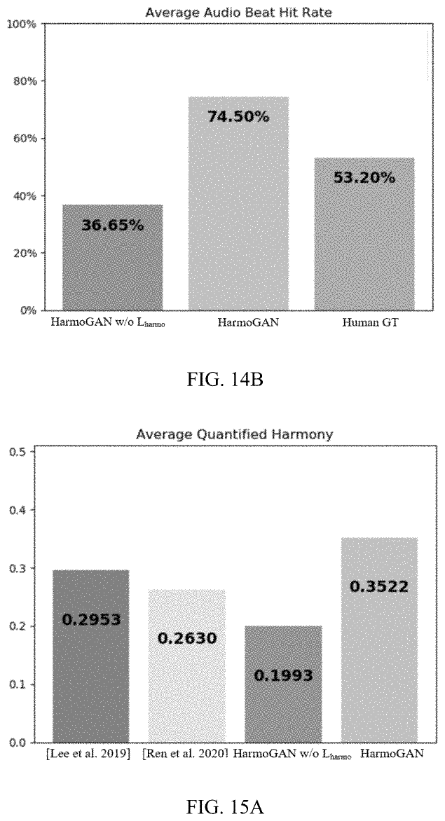

Apart from the quantified harmony derived from the harmony evaluation mechanism shown in FIG. 14A, the hit rate, which is popular in demonstrating harmonization, is also calculated to evaluate the performance. In FIG. 14B the hit rate for music beats is presented by computing the percentages of music beats that have been hit by the visual beat within the duration of the reaction delay. The human dancer basically hits half the music beats, which is a reasonable result considering the limited accuracy for data acquisition when obtaining motion sequences. Based on FIGS. 14A and 14B, it is obvious that with the incorporation of [symbol] ₕₐᵣₘₒ the performance of audio-visual harmony boosted compared to the variant without [symbol] ₕₐᵣₘₒ and surpasses the real dancer significantly. At the same time, it implies that [symbol] ₕₐᵣₘₒ requires the “privilege” to edit the motion sequences for harmonization, even though different from the ground truth, which can explain the relatively weak performance shown for the baseline variant without the use of [symbol] ₕₐᵣₘₒ as it is not designed to strictly simulate the ground truth. In all, the test on the self-created dataset demonstrates the outstanding performance of the HarmoGAN model, which can achieve improved audio-visual harmony between the given music sequences and the generated motions under the assistance of the harmony loss.

To further assess the ability of harmonization in the HarmoGAN model, in addition to the variant, the HarmoGAN model is compared against the other two powerful GAN-based state-of-the-art models proposed by [Lee et al., 2019] and [Ren et al., 2020], for audio-driven motion synthesis. For a fair comparison, all models are tested on the Ballroom dataset by [Gouyon et al., 2006], which is a public music dataset only providing background music for various dance types. The 42 clips of 6-second audio tracks are randomly collected from the Ballroom dataset as the testing dataset. Without any given ground-truth human movement, motion sequences in the training dataset are selected as the initial poses to generate the dance sequences.

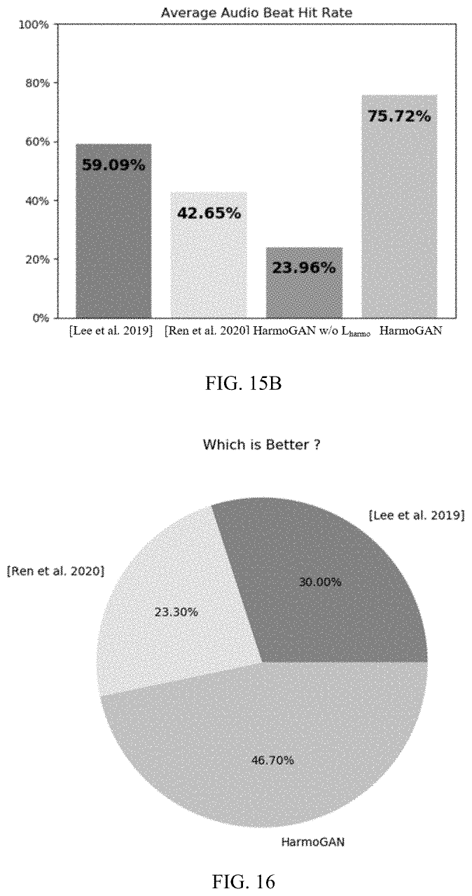

In FIGS. 15A and 15B, the results of quantified harmony and the hit rate of music beats are demonstrated by computing the average results of 7 types of dance music. It shows that the HarmoGAN model outperforms the other models distinctly in both metrics.

TABLE 1
Quantified harmony for 7 types of dance music

| Model name | Cha-cha | Jive | Quickstep | Rumba | Samba | Tango | Waltz |
|---|---|---|---|---|---|---|---|
| Lee et al. 2019 | 0.3509 | 0.3359 | 0.2773 | 0.2862 | 0.2805 | 0.2657 | 0.2704 |
| Ren et al. 2020 | 0.2759 | 0.3321 | 0.1625 | 0.2154 | 0.2761 | 0.2671 | 0.3122 |
| HarmoGAN | 0.1983 | 0.2337 | 0.1511 | 0.2104 | 0.2012 | 0.1929 | 0.2076 |
| w/o [symbol] | | | | | | | |
| HarmoGAN | 0.4097 | 0.3995 | 0.3199 | 0.3495 | 0.3468 | 0.2948 | 0.3455 |

TABLE 2
Audio beat hit rate for 7 types of dance music

| Model name | Cha-cha | Jive | Quickstep | Rumba | Samba | Tango | Waltz |
|---|---|---|---|---|---|---|---|
| Lee et al. 2019 | 58.10% | 59.92% | 53.03% | 64.91% | 64.93% | 58.46% | 54.30% |
| Ren et al. 2020 | 28.13% | 51.03% | 33.33% | 41.53% | 49.07% | 42.84% | 52.59% |
| HarmoGAN | 22.70% | 23.97% | 18.18% | 25.33% | 29.70% | 21.48% | 26.36% |
| w/o [symbol] | | | | | | | |
| HarmoGAN | 74.60% | 75.65% | 71.22% | 77.01% | 83.69% | 74.98% | 72.90% |

The detailed evaluation results for each dance type are shown in Table 1 and 2. Compared with the baseline HarmoGAN model without the use of [symbol] ₕₐᵣₘₒ, the assistance of spatial-temporal GCN proposed by [Ren et al., 2020] may intrinsically benefit the harmonization by regularizing the hierarchical representations of skeletons in the generation of motion sequences. However, such improvement lacks robustness and is highly affected by the bias in the training dataset. The post-processing beat warper proposed by [Lee et al., 2019] can relatively lift the performance evenly but is still limited. In comparison with the other models, the HarmoGAN model can directly produce distinct and robust improvement for the audio-visual harmony that is independent of the dance types.

In some embodiments, the HarmoGAN model can be performed to generate the visual sequences based on video frames. In some embodiments, a multi-stage or end-to-end system can be built to perform the audio-visual harmonization based on video frames.

In addition, the cost of the tested models is analyzed based on the number of model parameters and training pairs. The number of parameters for the generator in the HarmoGAN model is closer to that of [Ren et al., 2020] and half of that of [Lee et al., 2019], while [Lee et al., 2019], require a 10-times larger training dataset for obtaining the final model. Thus, considering the results of harmony evaluation for each model, it reveals that the HarmoGAN model can improve the performance efficiently without increasing too much the cost in both the training and testing phase.

To evaluate the audio-visual harmony qualitatively, the dance videos are synthesized by combining the audio sequences and the generated motions from the tested models. Then the user study is conducted to compare the perceptual harmony for the synthesized videos. 12 unprofessional participants are invited to watch the video pairs from the different 3 models. The unprofessional participants are asked to vote which is better in terms of the audio-visual harmony blindly.

As shown in FIG. 16, it can be concluded that the HarmoGAN model performs best with respect to the perceptual harmony, which is consistent with the results based on the quantitative metrics. The assumption that the harmony evaluation mechanism can accurately reflect the perceptual audio-visual harmony to some degree can also be verified.

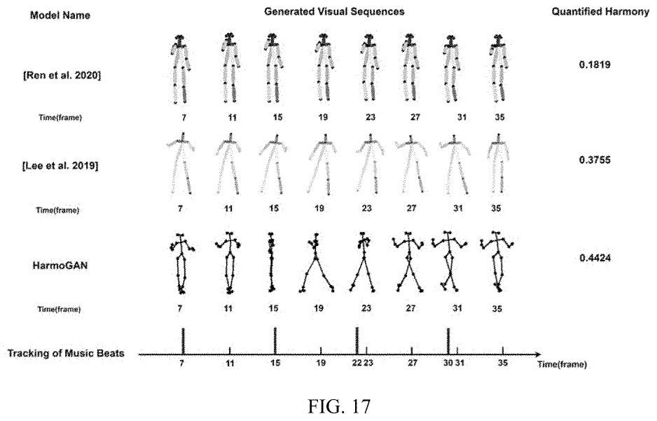

As an example of qualitative evaluation, as shown in FIG. 17, the generated motion sequences from the tested models are demonstrated based on the Ballroom dataset. Given the tracked audio beats, in the movements produced by [Ren et al., 2020], the distinct visual beats can hardly be perceived from the slight body swings, let alone the audio-visual consistency. When it comes to the visual results estimated from [Lee et al., 2019], reasonable visual beats can be perceived with the observation of changes between movements. However, such changes are relatively even in the whole sequences, which may suffer from the inattentional blindness and result in the perceptual inconsistency between audio-visual beats due to misjudgments. By comparison, the HarmoGAN model with the regularization of the harmony loss can produce distinct changes in motion close to the occurrences of the music beats to provide visual beats that can draw enough attention to favor the harmony evaluation based on the human perception.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A method for harmony-aware audio-driven motion synthesis, applied to a computing device, comprising:
determining a plurality of testing meter units according to an input audio, each testing meter unit corresponding to an input audio sequence of the input audio;
obtaining an auditory input corresponding to each testing meter unit;
obtaining an initial pose of each testing meter unit as a visual input based on a visual motion sequence synthesized for a previous testing meter unit; and
automatically generating a harmony-aware motion sequence corresponding to the input audio using a generator of a generative adversarial network (GAN) model, the GAN model being trained by incorporating a hybrid loss function, the hybrid loss function including a multi-space pose loss, a harmony loss, and a GAN loss, the harmony loss being determined according to beat consistencies of audio-visual beat pairs.

2. The method according to claim 1, further comprising:
training a GAN model to obtain the trained GAN model includes:
obtaining audio beats and audio beat strengths from a training sample audio, each audio beat corresponding to one audio beat strength;
determining a plurality of training meter units according to the audio beats and audio beat strengths, each training meter unit corresponding to a sample audio sequence of the training sample audio and a temporal index based on a time record of the training meter unit;
extracting features of the sample audio sequence of each training meter unit as a sample auditory input; and
obtaining a sample initial pose of each training meter unit as a sample visual input based on the temporal index and a training sample visual motion sequence; and
training the GAN model using the sample auditory input and the sample visual input of each training meter unit by incorporating the hybrid loss function, to obtain the trained GAN model, the harmony loss being determined according to beat consistencies of audio-visual beat pairs corresponding to each training meter unit, each audio beat in the audio-visual beat pairs being from the sample auditory input of the training meter unit, each visual beat in the audio-visual beat pairs being from an estimated visual motion sequence corresponding to the training meter unit generated during a process of training the GAN model.

3. The method according to claim 2, wherein training the GAN model further includes:
detecting visual beats of the estimated visual motion sequence by considering a difference between joint velocity sums in neighboring frames of the estimated visual motion sequence.

4. The method according to claim 2, wherein the beat consistencies of the audio-visual beat pairs corresponding to each training meter unit is determined by:
assigning a weight to each audio beat and a weight to each visual beat based on beat saliency;
obtaining, among the audio-visual beat pairs of the training meter unit, attentional beats according to the weights of the audio beats and the weights of the visual beats, the attentional beats including one or more attentional audio beats and one or more attentional visual beats;
obtaining the beat strength for each of the attentional beats; and
constructing hitting scores by counting labels in an audio and visual domain to represent aligned attentional beats in the sample auditory input and the estimated visual motion sequence, one label representing that one attentional audio beat is aligned with a corresponding attentional visual beat according to a human reaction time delay; and
determining the beat consistencies using the hitting scores.

5. The method according to claim 2, training the GAN model further includes:
segmenting audio-visual clips based on the plurality of training meter units temporally; and
inputting the segmented audio-visual clips for the training,
wherein the initial pose of each training meter unit is obtained from a corresponding audio-visual clip that contains the sample audio sequence.

6. The method according to claim 2, wherein:
the GAN model further includes a cross-domain discriminator and a spatial-temporal discriminator that jointly supervise the generator; and
training the GAN model further includes:
minimizing the harmony loss, the multi-space pose loss, and the GAN loss from the generator; and
maximizing values of loss functions of the cross-domain discriminator and the spatial temporal discriminator to distinguish between a real training sample and a fake training sample.

7. The method according to claim 1, wherein the multi-space pose loss includes one or more of Kullback-Leibler (KL) loss, Charbonnier-based MSE loss, and Charbonnier-based VGG loss.

8. The method according to claim 1, wherein:
the generator includes a GRU-based audio encoder and pose decoder;
the pose decoder is configured to:
estimate 2D poses according to a visual motion sequence corresponding to a meter unit; and
construct a depth lifting branch to produce 3D poses based on the estimated 2D poses.

9. The method according to claim 1, wherein:
determining the plurality of testing meter units according to the input audio includes:
determining the plurality of testing meter units according to audio beats and audio beat strengths of the input audio, each testing meter unit corresponding to an audio sequence of the input audio and a temporal index based on a time record of the testing meter unit;
obtaining the auditory input corresponding to each testing meter unit includes:
extracting features of the audio sequence of each testing meter unit as the auditory input; and
obtaining the initial pose of each testing meter unit as the visual input based on the visual motion sequence synthesized for the previous testing meter unit includes:
obtaining the initial pose of each testing meter unit as the visual input based on the temporal index and the visual motion sequence synthesized for the previous testing meter unit.

10. The method according to claim 9, wherein obtaining the initial pose of each testing meter unit comprises:
keeping the generated harmony-aware visual motion sequence from a previous testing meter unit right before a current testing meter unit in the initial pose of a current testing meter unit; and
using a mean pose of the generated harmony-aware motion sequence from the previous testing meter unit as initialization for the current testing meter unit.

11. A device for harmony-aware audio-driven motion synthesis, comprising:
a memory; and
a processor coupled to the memory and configured to perform a plurality of operations comprising:
determining a plurality of testing meter units according to an input audio, each testing meter unit corresponding to an input audio sequence of the input audio;
obtaining an auditory input corresponding to each testing meter unit;
obtaining an initial pose of each testing meter unit as a visual input based on a visual motion sequence synthesized for a previous testing meter unit; and
automatically generating a harmony-aware motion sequence corresponding to the input audio using a generator of a generative adversarial network (GAN) model, the GAN model being trained by incorporating a hybrid loss function, the hybrid loss function including a multi-space pose loss, a harmony loss, and a GAN loss, the harmony loss being determined according to beat consistencies of audio-visual beat pairs.

12. The device according to claim 11, wherein the plurality of operations performed by the processor further comprises:
training the GAN model, including:
obtaining audio beats and audio beat strengths from a training sample audio, each audio beat corresponding to one audio beat strength;
determining a plurality of training meter units according to the audio beats and audio beat strengths, each training meter unit corresponding to a sample audio sequence of the training sample audio and a temporal index based on a time record of the training meter unit;
extracting features of the sample audio sequence of each training meter unit as a sample auditory input; and
obtaining a sample initial pose of each training meter unit as a sample visual input based on the temporal index and a training sample visual motion sequence; and
training the GAN model using the sample auditory input and the sample visual input of each training meter unit by incorporating the hybrid loss function, to obtain the trained GAN model, the harmony loss being determined according to beat consistencies of audio-visual beat pairs corresponding to each training meter unit, each audio beat in the audio-visual beat pairs being from the sample auditory input of the training meter unit, each visual beat in the audio-visual beat pairs being from an estimated visual motion sequence corresponding to the training meter unit generated during a process of training the GAN model.

13. The device according to claim 12, wherein training the GAN model further includes:
detecting visual beats of the estimated visual motion sequence by considering a difference between joint velocity sums in neighboring frames of the estimated visual motion sequence.

14. The device according to claim 12, wherein the beat consistencies of the audio-visual beat pairs corresponding to each training meter unit is determined by:
assigning a weight to each audio beat and a weight to each visual beat based on beat saliency;
obtaining, among the audio-visual beat pairs of the training meter unit, attentional beats according to the weights of the audio beats and the weights of the visual beats, the attentional beats including one or more attentional audio beats and one or more attentional visual beats;
obtaining the beat strength for each of the attentional beats; and
constructing hitting scores by counting labels in an audio and visual domain to represent aligned attentional beats in the sample auditory input and the estimated visual motion sequence, one label representing that one attentional audio beat is aligned with a corresponding attentional visual beat according to a human reaction time delay; and
determining the beat consistencies using the hitting scores.

15. The device according to claim 12, training the GAN model further includes:
segmenting audio-visual clips based on the plurality of training meter units temporally; and
inputting the segmented audio-visual clips for the training,
wherein the initial pose of each training meter unit is obtained from a corresponding audio-visual clip that contains the sample audio sequence.

16. The device according to claim 12, wherein:
the GAN model further includes a cross-domain discriminator and a spatial-temporal discriminator that jointly supervise the generator; and
training the GAN model further includes:
minimizing the harmony loss, the multi-space pose loss, and the GAN loss from the generator; and
maximizing values of loss functions of the cross-domain discriminator and the spatial temporal discriminator to distinguish between a real training sample and a fake training sample.

17. The device according to claim 11, wherein the multi-space pose loss includes one or more of Kullback-Leibler (KL) loss, Charbonnier-based MSE loss, and Charbonnier-based VGG loss.

18. The device according to claim 11, wherein:
the generator includes a GRU-based audio encoder and pose decoder;
the pose decoder is configured to:
estimate 2D poses according to a visual motion sequence corresponding to a meter unit; and
construct a depth lifting branch to produce 3D poses based on the estimated 2D poses.

19. The device according to claim 11, wherein:
determining the plurality of testing meter units according to the input audio includes:
determining the plurality of testing meter units according to audio beats and audio beat strengths of the input audio, each testing meter unit corresponding to an audio sequence of the input audio and a temporal index based on a time record of the testing meter unit;
obtaining the auditory input corresponding to each testing meter unit includes:
extracting features of the audio sequence of each testing meter unit as the auditory input; and
obtaining the initial pose of each testing meter unit as the visual input based on the visual motion sequence synthesized for the previous testing meter unit includes:
obtaining the initial pose of each testing meter unit as the visual input based on the temporal index and the visual motion sequence synthesized for the previous testing meter unit.

20. The device according to claim 19, wherein obtaining the initial pose of each testing meter unit comprises:
keeping the generated harmony-aware visual motion sequence from a previous testing meter unit right before a current testing meter unit in the initial pose of a current testing meter unit; and
using a mean pose of the generated harmony-aware motion sequence from the previous testing meter unit as initialization for the current testing meter unit.
